(19) United States
(12) Patent Application Publication
(10) Pub. No.: US 2014/0068703 A1
(43) Pub. Date: Mar. 6, 2014

(54) SYSTEM AND METHOD PROVIDING POLICY BASED DATA CENTER NETWORK AUTOMATION

(71) Applicants: FLORIN S. BALUS, MOUNTAIN VIEW, CA (US); SURESH BODDAPATI, MOUNTAIN VIEW, CA (US); SUNIL S. KHANDEKAR, MOUNTAIN VIEW, CA (US); DIMITRIOS STILIADIS, MOUNTAIN VIEW, CA (US)

(72) Inventors: FLORIN S. BALUS, MOUNTAIN VIEW, CA (US); SURESH BODDAPATI, MOUNTAIN VIEW, CA (US); SUNIL S. KHANDEKAR, MOUNTAIN VIEW, CA (US); DIMITRIOS STILIADIS, MOUNTAIN VIEW, CA (US)

(21) Appl. No.: 13/841,613

(22) Filed: Mar. 15, 2013

Related U.S. Application Data
(60) Provisional application No. 61/693,996, filed on Aug. 28, 2012.

(51) Int. Cl. H04L 29/06

(52) U.S. Cl. CPC H04L 63/20
USPC 726/1

(57) ABSTRACT

Systems, methods, architectures and/or apparatus for implementing policy-based management of network resources within a data center (DC) by detecting compute events via the hypervisor and responsively generating a registration event in which a policy-based determination is made regarding event authorization and DC resource allocation.

### CROSS-REFERENCE TO RELATED APPLICATION

Applicants claim the benefit of prior provisional patent application Ser. No. 61/693,996, filed Aug. 28, 2012 and entitled SYSTEM, METHOD AND APPARATUS FOR DATA CENTER AUTOMATION, which application is incorporated herein by reference in its entirety.

### FIELD OF THE INVENTION

The invention relates to the field of data centers and, more particularly but not exclusively, to management of secure data centers.

### BACKGROUND

Data Center (DC) architecture generally consists of a large number of compute and storage resources that are interconnected through a scalable Layer-2 or Layer-3 infrastructure. In addition to this networking infrastructure running on hardware devices the DC network includes software networking components (vswitches) running on general purpose compute, and dedicated hardware appliances that supply specific network services such as load balancers, ADCs, firewalls, IPS/IDS systems etc. The DC infrastructure can be owned by an Enterprise or by a service provider (referred as Cloud Service Provider or CSP), and shared by a number of tenants. Compute and storage infrastructure are virtualized in order to allow different tenants to share the same resources. Each tenant can dynamically add/remove resources from the global pool to/from its individual service.

DC network must be able to dynamically assign resources to each tenant while maintaining strict performance isolation between different tenants (e.g., different companies). Furthermore, tenants can be sub-divided into sub-tenants (e.g., different corporate departments) with strict isolation between them as well. For example, an enterprise requires resources in a CSP DC that are partitioned between different departments.

Unfortunately, existing brute force or “manager of managers” techniques for control plane management of thousands of nodes are becoming both in efficient and overly expensive as DC infrastructure becomes larger.

Specifically, typical data center management requires a complex orchestration of storage, compute and network element management systems. The network element management system must discover the network infrastructure used to implement the data center, as well as the bindings of the various DC compute/storage servers to the network elements therein. The compute management system and storage management system operate to create new virtual machines and provision all of the VM compute and storage resources to be made available to tenants via the network infrastructure. In the event of a failure of a VM related resource, the entire process of creating new VMs and provisioning the various VM compute and storage resources must be repeated. This is a complex, slow and inefficient process.

### SUMMARY

Various deficiencies in the prior art are addressed by systems, methods, architectures, mechanisms and/or apparatus implementing policy-based management of network resources within a data center (DC) by detecting compute events (e.g., VM instantiation request) at the hypervisor and responsively generating a registration event in which a policy-based determination is made regarding event authorization and DC resource allocation. For example, in various embodiments, each hypervisor instantiation/teardown of a VM (for appliance access) is detected by a VirtualSwitch Agent (VAg) instantiated within the hypervisor, which informs a VirtualSwitch Control Module (VCM) running on a switch of the compute event. The VCM communicates with a management entity having access to policy information (e.g., Service Level Agreements), which uses the policy information to determine if the VM is authorized and responsively provision appropriate resources.

A method according to one embodiment for instantiating network services within a data center (DC), comprises creating a registration event in response to a detected compute event; retrieving policy information associated with the detected compute event to identify thereby relevant types of services; and configuring DC services to provide the relevant types of services if the detected compute event is authorized.

### BRIEF DESCRIPTION OF THE DRAWINGS

The teachings herein can be readily understood by considering the following detailed description in conjunction with the accompanying drawings, in which:

FIG. 1 depicts a high-level block diagram of a system benefiting from various embodiments;

FIGS. 2-5 depict flow diagrams of methods according to various embodiments; and

FIG. 6 depicts a high-level block diagram of a computing device suitable for use in performing the functions described herein.

To facilitate understanding, identical reference numerals have been used, where possible, to designate identical elements that are common to the figures.

### DETAILED DESCRIPTION OF THE INVENTION

The invention will be discussed within the context of systems, methods, architectures, mechanisms and/or apparatus implementing policy-based management of network resources within a data center (DC) by detecting compute events (e.g., VM instantiation request) at the hypervisor level and responsively generating a registration event in which a policy-based determination is made regarding event authorization and DC resource allocation. However, it will be appreciated by those skilled in the art that the invention has broader applicability than described herein with respect to the various embodiments.

In addition, while the various embodiments are discussed within the context of specific equipment configurations, protocols, mechanisms and the like, more and different equipment configurations, protocols, mechanisms and the like are also contemplated by the inventors as being applicable for use within the various embodiments. For example, various embodiments will be described within the context of a data center (DC) equipment rack comprising a centralized controller running on a VM or in the ToR control plane module and one or more physical servers or server elements.

Generally speaking, each of the physical servers or server elements comprises a host machine upon which virtual services utilizing compute/storage resources are instantiated by a hypervisor or virtual machine monitor (VMM) running on, or associated with, the server. The hypervisor comprises a software, hardware or combination of software and hardware adapted to instantiate, terminate and otherwise control one or more virtualized service on a server. In various embodiments, the server associated with a single rack are collectively operative to support the instantiation of, illustratively, 40 virtual switches (VSWs). It will be appreciated that more or fewer servers, instantiated switches and the like may be provided within a particular equipment rack or cluster within the DC. As such, the specification figures at times indicates that 40 communication paths are being utilized for a particular function. As will be readily appreciated, more or fewer than 40 communication paths may be used, more or fewer VSWs be used and so on.

Virtualized services as discussed herein generally described any type of virtualized compute and/or storage resources capable of being provided to a tenant. Moreover, virtualized services also include access to non-virtual appliances or other devices using virtualized compute/storage resources, data center network infrastructure and so on.

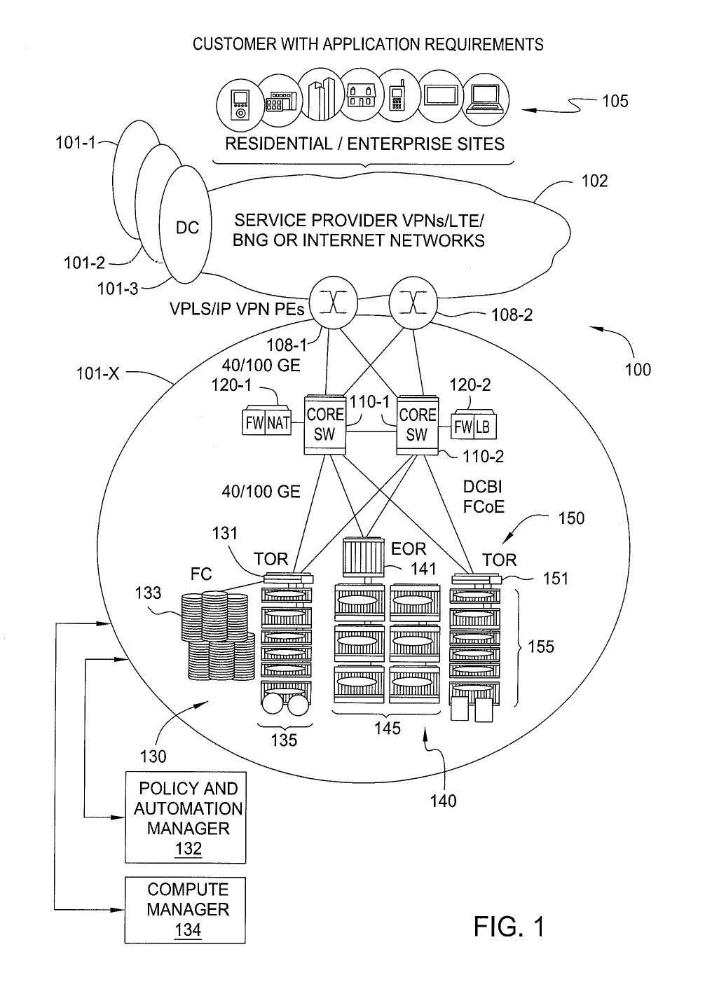

FIG. 1 depicts a high-level block diagram of a system benefiting from various embodiments. Specifically, FIG. 1 depicts a system 100 comprising a plurality of data centers (DC) 101-1 through 101-X (collectively data centers 101) operative to provide compute and storage resources to numerous customers having application requirements at residential and/or enterprise sites 105 via one or more networks 102.

The customers having application requirements at residential and/or enterprise sites 105 interact with the network 102 via any standard wireless or wireline access networks to enable local client devices (e.g., computers, mobile devices, set-top boxes (STB's), storage area network components, Customer Edge (CE) routers, access points and the like) to access virtualized compute and storage resources at one or more of the data centers 101.

The networks 102 may comprise any of a plurality of available access network and/or core network topologies and protocols, alone or in any combination, such as Virtual Private Networks (VPNs), Long Term Evolution (LTE), Border Network Gateway (BNG), Internet networks and the like.

The various embodiments will generally be described within the context of IP networks enabling communication between provider edge (PE) nodes 108. Each of the PE nodes 108 may support multiple data centers 101. That is, the two PE nodes 108-1 and 108-2 depicted in FIG. 1 as communicating between networks 102 and DC 101-X may also be used to support a plurality of other data centers 101.

The data center 101 (illustratively DC 101-X) is depicted as comprising a plurality of core switches 110, a plurality of service appliances 120, a first resource cluster 130, a second resource cluster 140, and a third resource cluster 150.

Each of, illustratively, two PE nodes 108-1 and 108-2 is connected to each of the illustratively, two core switches 110-1 and 110-2. More or fewer PE nodes 108 and/or core switches 110 may be used; redundant or backup capability is typically desired. The PE routers 108 interconnect the DC 101 with the networks 102 and, thereby, other DCs 101 and end-users 105. The DC 101 is generally organized in cells, where each cell can support thousands of servers and virtual machines.

Each of the core switches 110-1 and 110-2 is associated with a respective (optional) service appliance 120-1 and 120-2. The service appliances 120 are used to provide higher layer networking functions such as providing firewalls, performing load balancing tasks and so on.

The resource clusters 130-150 are depicted as compute and/or storage resources organized as racks of servers implemented either by multi-server blade chassis or individual servers. Each rack holds a number of servers (depending on the architecture), and each server can support a number of processors. A set of network connections connect the servers with either a Top-of-Rack (ToR) or End-of-Rack (EoR) switch. While only three resource clusters 130-150 are shown herein, hundreds or thousands of resource clusters may be used. Moreover, the configuration of the depicted resource clusters is for illustrative purposes only; many more and varied resource cluster configurations are known to those skilled in the art. In addition, specific (i.e., non-clustered) resources may also be used to provide compute and/or storage resources within the context of DC 101.

Exemplary resource cluster 130 is depicted as including a ToR switch 131 in communication with a mass storage device(s) or storage area network (SAN) 133, as well as a plurality of server blades 135 adapted to support, illustratively, virtual machines (VMs). Exemplary resource cluster 140 is depicted as including a EoR switch 141 in communication with a plurality of discrete servers 145. Exemplary resource cluster 150 is depicted as including a ToR switch 151 in communication with a plurality of virtual switches 155 adapted to support, illustratively, the VM-based appliances.

In various embodiments, the ToR/EoR switches are connected directly to the PE routers 108. In various embodiments, the core or aggregation switches 120 are used to connect the ToR/EoR switches to the PE routers 108. In various embodiments, the core or aggregation switches 120 are used to interconnect the ToR/EoR switches. In various embodiments, direct connections may be made between some or all of the ToR/EoR switches.

As will be discussed in more detail below, a VirtualSwitch Control Module (VCM) running in the ToR switch gathers connectivity, routing, reachability and other control plane information from other routers and network elements inside and outside the DC. The VCM may run also on a VM located in a regular server. The VCM then programs each of the virtual switches with the specific routing information relevant to the virtual machines (VMs) associated with that virtual switch. This programming may be performed by updating L2 and/or L3 forwarding tables or other data structures within the virtual switches. In this manner, traffic received at a virtual switch is propagated from a virtual switch toward an appropriate next hop over a tunnel between the source hypervisor and destination hypervisor using an IP tunnel. The ToR switch performs just tunnel forwarding without being aware of the service addressing.

Generally speaking, the “end-users/customer edge equivalents” for the internal DC network comprise either VM or server blade hosts, service appliances and/or storage areas. Similarly, the data center gateway devices (e.g., PE servers 108) offer connectivity to the outside world; namely, Internet, VPNs (IP VPNs/VPLS/VPWS), other DC locations, Enterprise private network or (residential) subscriber deployments (BNG, Wireless (LTE etc), Cable) and so on.

Policy Automation Functions

In addition to the various elements and functions described above, the system 100 of FIG. 1 further includes a policy and automation manager 192 as well as a computer manager 194.

The policy and automation manager 192 is adapted to support various policy-based data center network automation functions as will now be discussed.

The policy-based data center network automation functions are adapted to enable rapid instantiation of virtual machines (VMs) or virtual services using compute and/or storage resources within the data center in a policy-compliant manner. Various embodiments provide efficient data center management via policy-based service discovery and binding functions.

Of particular interest to the following discussion are the previously-described VirtualSwitch Control Module (VCM) and virtualswitch Agent (VAg). The VCM may be included within a ToR or EoR switch (or some other switch), or may be an independent processing device. One or multiple VCMs can be deployed in each data center depending on the size of the data center and the capacity of the each VCM. The VAg, may be included within a VSW.

Tenant VMs attach to hypervisors that reside in servers. When a VM is attached to the hypervisor, a mechanism is required for mapping VMs to particular tenant network instances. This mechanism distributes state information related to the VMs, and this state information is used to attach VMs to specific tenant network selectors and provide thereby the necessary policies.

Tenant VMs can also attach directly to the ToR or EoR switches, where a similar Tenant Selector function will map tenant traffic to particular VRF (virtual forwarding instances). Traffic is encapsulated with some form of tunnel header and is transmitted between tunnel selectors. A control layer protocol allows Tunnel Selectors to map packets to specific tunnels based on their destination. At the core of the network, a control plane is used to allow the routing of traffic between tunnel selectors. Depending on the chosen technologies, the mapping between packets and tunnels can be based on L2 or L3 headers or any combination of fields in the packet headers in general.

The various embodiments provide scalable multi-tenant network services to enable the instantiation of services without multiple configuration steps. The various embodiments are based on the principle that tenant specific information is stored in a scalable policy server. Network elements detect “events” that represent requests for network services by servers, storage or other components. Based on these events, network elements will automatically set-up the services requested, after validating the requests with the policy server.

In particular, various embodiments contemplate that end users will instantiate virtual services requiring compute, storage, and/or other resources via a cloud management tool. These resources must be interconnected through a multi-tenant network, so that a given tenant can only have access to its own specific resources. The DC solution must be configured to capture these events, by utilizing APIs (Application Programming Interfaces) to compute and storage infrastructure components or other packet information, and it must automatically instantiate the tenant network. When an event is detected by a Virtual Controller Module at the edge of the network, the policy server is consulted to identify the right action profile. If the event is a virtual machine instantiation, the policy server will provide the necessary information that must be used for the network associated with this virtual machine. The Virtual Controller Module uses this information to enforce the policies at the edge of the network, and encapsulate traffic with the proper headers.

Policy enforcement and traffic encapsulation can be instantiated either in the VSW resident in the corresponding server or in the ToR switch if such functionality is not available at the edge node.

A data center (DC), such as the DC 101 described herein, typically includes compute/storage resources provided via racks of servers, where each server rack has associated with it a physical switch such as a Top-of-Rack (ToR) or End-of-Rack (EoR) switch.

One or more virtual switches (VSWs) are instantiated within each of the servers via a respective hypervisor or virtual machine manager within each server, such as when virtualized networking is deployed. A VSW agent (VAg) is associated with each VSW. The VAg can be instantiated to run in the same machine as the VSW or it can run in a different machine and utilize APIs provided by the hypervisor to reach the VSW.

The ToR or EoR switch is a physical switch providing, illustratively, a high-density 10G/40G/100G Ethernet switching solution. The ToR switch includes a Virtualswitch Controller Module (VCM) that is responsible for controlling all VSWs attached to the specific ToR. The VCM provides an interface that allows network administrators to monitor and modify the behavior of the corresponding VSWs. The VCM also includes various protocol capabilities to enable the VSWs and the ToR to operate as an integrated switch cluster. For example, in the case of BGP IPVPN tunnels, the VSWs perform the tunnel encapsulation, but the VCM participates in the BGP protocol and programs the correct routes to the VSW. The programming of routes is done by enabling a communication path (VSW control) between the VCM and the VAg.

The ToR communicates directly with provider edge (PE) routers linking the PC to other networks, or with aggregation/core routers forming a DC network between the ToRs and the PE routers. The aggregation/core routers may be implemented as a very high-capacity Ethernet switch supporting L2/L3 switching features.

Policy and Automation Manager 192 operates as a Cloud Network Automation (CNA) entity and includes various software components adapted for automating the operation of the network. The CNA is responsible for user management data bases, policy configuration and maintenance, cross-system interfaces, and exposure with the outside world. The CNA includes a policy server that holds all the policies associated with each tenant, which policies are accessed by the VCM or a ToR when a new network service or VM must be instantiated in order to associate a profile with the new network service or VM. The CNA may provide a per-tenant view of a solution that provides a single management interface for all tenant traffic.

Any of a plurality of known Compute Management portal or tools such as provided by a computer manager 194 may be used for compute and virtual machine management such as VMware vCenter/vCloud, HP CSA, Nimbula, Cloud.com, Oracle, etc. In particular, the various embodiments described herein are generally operable with the various compute management portal or tools. It will be appreciated that the terms Compute Manager and Compute Management Portal may refer to different entities in some embodiments and the same entities in other embodiments. That is, these two functions are combined in some embodiments, while separated in other embodiments.

Generally speaking, various embodiments operate to automate the instantiation of network services within the data center using a distributed mechanism as will now be described in more detail. Briefly, the mechanism is based in part on the following principles:

(1) Network services are always auto-instantiated by the edge network devices;

(2) Intelligent mechanisms residing in the network detect “compute events” at the edges of the network such as the addition/removal of virtual machines or storage components;

(3) When such events are detected, the CNA is consulted to identify the types of services that must be provided via one or more network elements in response to the detected compute event;

(4) The CNA has been populated with information from cloud management or other administrative tools; and

(5) Once network services and associated policies are identified, they are applied/provided in a distributed manner by the network elements, and CNA maintains a consistent view of the services that have been applied for each tenant of the system and all the physical and virtual elements involved in these services.

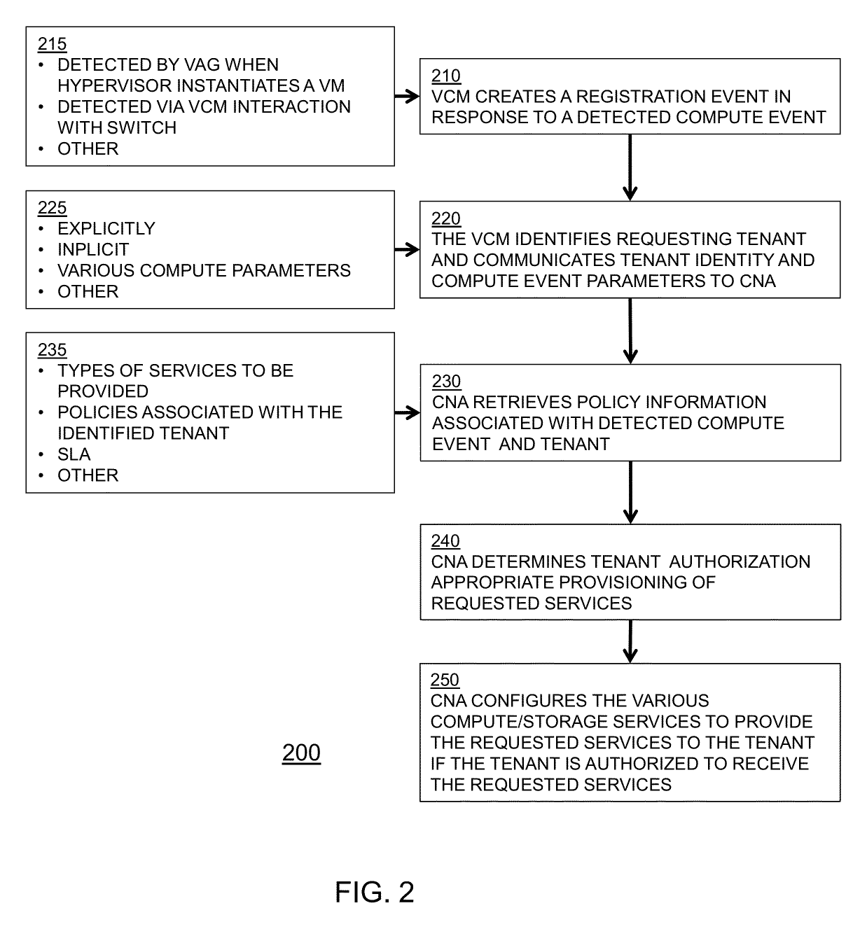

FIG. 2 depicts a flow diagram of a method according to an embodiment. Specifically, FIG. 2 depicts a flow diagram of a method 200 for automatically instantiating network services within a data center.

At step 210, the VCM creates a registration event in response to a detected compute event at the edge of the DC network. The detected compute event comprises an interaction indicative of a request to add or remove virtual compute or storage resources. The compute event may also comprise interaction indicative of a request to add or remove an appliance, such as an appliance accessed using virtual compute or storage resources. Referring to box 215, a compute event may be detected by a VAg instantiated within a hypervisor when a request is made to the hypervisor to instantiate a virtual machine (VM), edge device or other virtual service, such as via a compute management portal or tool (or other mechanism). The VAg forwards information pertaining to the captured compute event to the VCM, which responsively invokes a registration event or mechanism.

At step 220, the VCM identifies the requesting tenant and communicates the tenant identity and compute event parameters to the CNA. Referring to box 225, the requesting tenant may be identified explicitly via a tenant identifier or implicitly via source address or other information. The compute event parameters define the virtual compute or storage resources to be added, removed or otherwise processed.

At step 230, the CNA retrieves policy information associated with the detected compute event, as well as policy information associated with the identified tenant. Referring to box 235, the detected event policy information identifies the types of services to be provided by various network elements in response to the compute event, while the tenant policy information identifies policies associated with the identified tenant, such as defined by a Service Level Agreement (SLA) and the like.

At step 240, the CNA determines whether the identified tenant is authorized to receive the requested services as well as an appropriate provisioning of virtualized compute/storage resources to provide the requested services.

At step 250, the CNA configures the various compute/storage services to provide the requested services to the tenant if the tenant is authorized to receive the requested services.

It is noted that the various embodiments described herein contemplate a VCM residing at a ToR or other physical switch. However, in various embodiments the VCM resides at other physical or virtual locations.

The above described methodology provides automatic admission control of DC tenants requesting compute/storage resources to implement various virtual services or machines.

On-boarding tenants and guest tenants. In various embodiments, it is desirable to provide automated and mission controlled to DC tenants that are known to the DC service provider. In these embodiments, before any function is performed in the network, the tenant must be on-boarded into the system. This process can utilize one of multiple interfaces.

The main goal of the on boarding process is adapted to populate the policy servers of CNA with tenant related information. In various embodiments where tenant on-boarding is not used, a default set of policies may be applied to an unknown or “guest” tenant.

Tenant related information may include a plurality of policies, such as one or more of the following:

(1) Tenant users and/or groups. This information provides the relationship between users that will be used to drive the policy decisions. For example an enterprise can partition its users to development, administration, and finance groups and can associate different policies with different groups.

(2) Security policies associated with specific users and groups. Such policies define for example, whether VMs instantiated by specific users can communicate with other VMs in the systems or with the external world. Security policies can be based on VMs, applications, protocols and protocol numbers or any other mechanism.

(3) Quality-of-service (bandwidth, loss rate, latency) requirements associated with specific users or groups, for example, the maximum bandwidth that a VM can request from the network or the maximum bandwidth that a set of users belonging in a group can request and so on.

(4) Quota parameters such as the maximum number of VMs or networks that a user can instantiate, or the maximum number of networks that that be used etc.

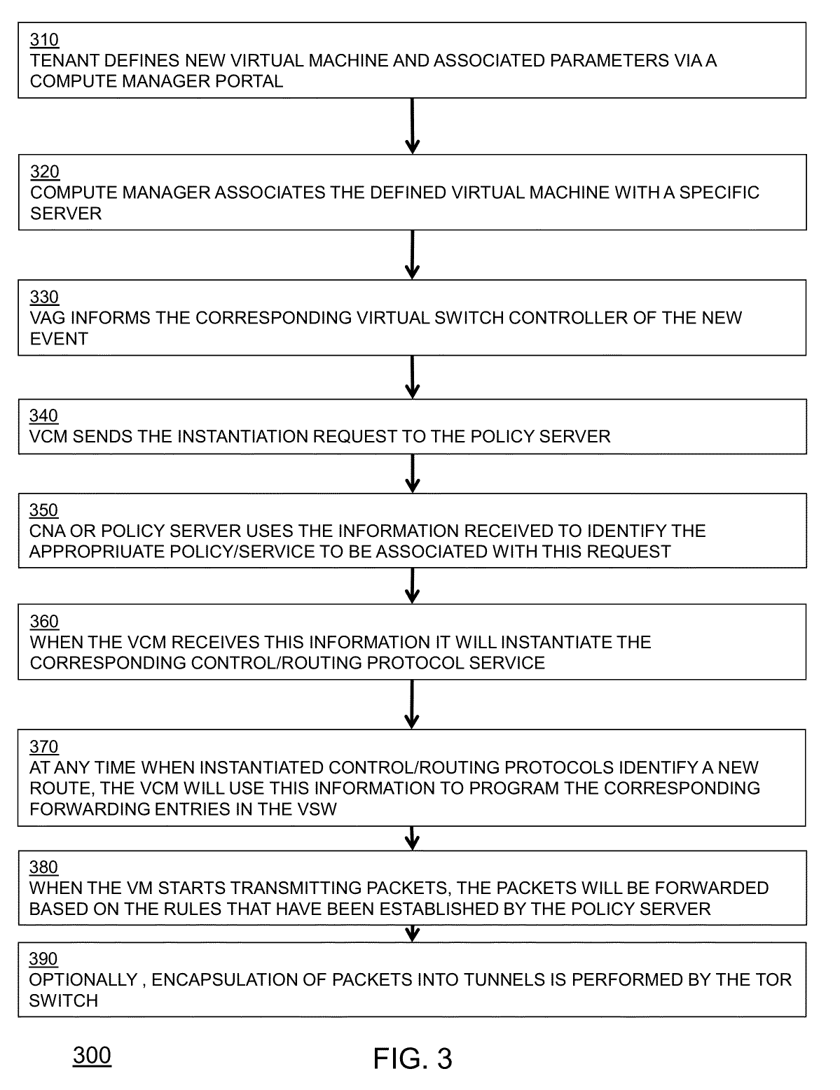

FIG. 3 depicts flow diagram of a method according to an embodiment. Specifically, FIG. 3 depicts a flow diagram of a method for tenant instantiation and network connection of a new virtual machine according to an embodiment. For purposes of this discussion, a simple scenario will be assumed wherein one tenant needs to instantiate a new virtual machine and connect it to a network.

At step 310, via a compute management portal or tool (or other mechanism), a tenant defines a new virtual machine and its associated parameters. For example the tenant may define the number of CPUs that must be used, the memory associated with the VM, the disk of the VM and so on. The tenant may also define the network interfaces of the machine. In various embodiments, the compute manager also defines the network (or networks) associated with this virtual machine. For each of these networks the user can request specific QoS and/or security services. Parameters in the definition can include QoS requirements, ACLs for L3 access to the machines, rate shapers, netflow parameters, IP address for the subnet and so on. In various embodiments, the virtual machine definition is encapsulated in an XML file, such as following sample XML file:

```
<domain type=‘kvm’>
  <name>Begonia</name>
  <uuid>667ceab4-9aff-11e1-ac3b-003048b11890</uuid>
  <metadata>
    <nuage xmlns=‘alcatel-lucent.com/nuage/cna’>
      <enterprise name=‘Archipel Corp’/>
      <group name=‘Dev’/>
      <user name=‘contact@archipelproject.org’/>
      <application name=‘Archipel’/>
      <nuage_network type=‘ipv4’ name=‘Network D’>
        <ip netmask=‘255.255.255.0’ gateway=‘192.168.13.1’
address=‘192.168.13.0’/>
          <interface_mac address=‘DE:AD:DD:84:83:46’/>
        </nuage_network>
      </nuage>
    </metadata>
    <memory>125952</memory>
    <currentMemory>125952</currentMemory>
    <vcpu>1</vcpu>
    <os>
      <type machine=‘rhe16.2.0’ arch=‘x86_64’>hvm</type>
      <boot dev=‘hd’/>
      <bootmenu enable=‘no’/>
    </os>
    <features>
      <acpi/>
      <apic/>
    </features>
    <clock offset=‘utc’/>
    <on_poweroff>destroy</on_poweroff>
    <on_reboot>restart</on_reboot>
    <on_crash>restart</on_crash>
    <devices>
      <emulator>/usr/libexec/qemu-kvm</emulator>
      <controller index=‘0’ type=‘usb’>
        <address slot=‘0x01’ bus=‘0x00’ domain=‘0x0000’
  type=‘pci’ function=‘0x2’/>
      </controller>
      <interface type=‘bridge’>
        <mac address=‘de:ad:dd:84:83:46’/>
        <source bridge=‘alubr0’/>
        <target dev=‘DEADDD848346’/>
        <model type=‘rt18139’/>
        <bandwidth>
        </bandwidth>
        <address slot=‘0x03’ bus=‘0x00’ domain=‘0x0000’
  type=‘pci’ function=‘0x0’/>
      </interface>
      <input bus=‘usb’ type=‘tablet’/>
      <input bus=‘ps2’ type=‘mouse’/>
      <graphics autoport=‘yes’ keymap=‘en-us’ type=‘vnc’ port=‘-
  1’/>
      <video>
        <model type=‘cirrus’ vram=‘9216’ heads=‘1’/>
        <address slot=‘0x02’ bus=‘0x00’ domain=‘0x0000’
  type=‘pci’ function=‘0x0’/>
      </video>
      <memballoon model=‘virtio’>
        <address slot=‘0x04’ bus=‘0x00’ domain=‘0x0000’
  type=‘pci’ function=‘0x0’/>
      </memballoon>
    </devices>
</domain>
```

At step 320, the compute manager associates the defined virtual machine with a specific server. In one embodiment, the configuration process is initiated by sending a configuration file (such as the exemplary XML file described above with respect to step 310) to the corresponding hypervisor. The VAg registers with the hypervisor, and when such an instantiation takes place the VAg retrieves the configuration parameters, including the virtual machine id, virtual machine name, network name, and tenant related information. This information explicitly identifies the tenant to whom the VM belongs and the service that the tenant wants.

At step 330, the VAg informs the corresponding virtual switch controller of the new event via a dedicated communications channel. In this process, the VCM is notified that a VM from the particular tenant is started in the network, and needs to connect to a specific network.

At step 340, the VCM sends the instantiation request to the policy server to determine if this is indeed acceptable and what are the port profile parameters that must be enforced based on the associated policies with the particular tenant. The information sent by the VCM to the ToR includes substantially all of the fields that were used to instantiate the VM.

```
<iq id=“dv4R5-4” to=“cna@localhost/nuage”
from=“tor@localhost/nuage”
    type=“get”>
    <query xmlns=“alu:iq:nuage”>
        <domain type=“kvm”>
            <name>Test</name>
            <uuid>1c003190-7a4b-11e1-9fc6-00224d697679</uuid>
            <memory>131072</memory>
            <currentMemory>131072</currentMemory>
            <vcpu>2</vcpu>
            <metadata>
                <nuage xmlns=“alcatel-lucent.com/nuage/cna”>
                    <user name=“bob” />
                    <group name=“finance” />
                    <enterprise name=“BOA” />
                    <!-- application decides the VRF -->
                    <application name=“webapp” />
                    <!-- subnet decides the IP address of the
interface -->
                    <nuage_network name=“blabla” type=“ipv4”>
                        <interface_mac
                        address=“de:ad:a2:c4:b4:3e” />
                        <bandwidth>
                            <inbound average=“1000” peak=“5000”
burst=“5120” />
                            <outbound average=“1000”
                            peak=“5000”
burst=“5120” />
                        </bandwidth>
                        <ip address=“192.168.1.0”
netmask=“255.255.255.0” gateway=“192.168.1.1” />
                    </nuage_network>
                    <nuage_network name=“blabla1” type=“ipv4”>
                        <interface_mac
                        address=“de:ad:0e:3e:4a:20” />
                        <bandwidth>
                            <inbound average=“1000” peak=“5000”
burst=“5130” />
                            <outbound average=“1000”
                            peak=“5000”
burst=“5130” />
                        </bandwidth>
                        <ip address=“192.168.2.0”
netmask=“255.255.255.0” gateway=“192.168.2.1” />
                    </nuage_network>
                </nuage>
            </metadata>
            <os>
                <type machine=“rhe16.2.0”
                arch=“x86_64”>hvm</type>
                <boot dev=“hd” />
                <bootmenu enable=“no” />
            </os>
            <features>
                <acpi />
                <apic />
                <pae />
            </features>
            <clock offset=“utc” />
            <on_poweroff>destroy</on_poweroff>
            <on_reboot>restart</on_reboot>
            <on_crash>restart</on_crash>
            <devices>
                <emulator>/usr/libexec/qemu-kvm</emulator>
                <disk device=“disk” type=“file”>
                    <driver cache=“none” type=“qcow2”
                    name=“qemu” />
                    <source file=“/vm//drives/7c003190-7a4b-11e1-
9fc6-00224d69f877/d0.qcow2” />
                    <target bus=“ide” dev=“hda” />
                    <address bus=“0” controller=“0” type=“drive”
unit=“0” />
                </disk>
                <controller index=“0” type=“ide”>
                    <address slot=“0x01” bus=“0x00”
domain=“0x0000” type=“pci”
                        function=“0x1” />
                </controller>
                <interface type=“bridge”>
                    <mac address=“de:ad:a2:c4:b4:3e” />
                    <source bridge=“virbr0” />
                    <model type=“rt18139” />
                    <target dev=“de:ad:a2:c4:b4:3e” />
                    <bandwidth>
                    </bandwidth>
                    <address slot=“0x03” bus=“0x00”
domain=“0x0000” type=“pci”
                        function=“0x0” />
                </interface>
                <interface type=“network”>
                    <mac address=“de:ad:0e:3e:4a:20” />
                    <source network=“default” />
                    <target dev=“de:ad:0e:3e:4a:20” />
                    <model type=“rt18139” />
                    <bandwidth>
                    </bandwidth>
                    <address slot=“0x04” bus=“0x00”
domain=“0x0000” type=“pci”
                        function=“0x0” />
                </interface>
                <input bus=“usb” type=“tablet” />
                <input bus=“ps2” type=“mouse” />
                <graphics autoport=“yes” keymap=“en-us” type=“vnc”
port=“−1” />
                <video>
                    <model type=“cirrus” vram=“9216” heads=“1” />
                    <address slot=“0x02” bus=“0x00”
domain=“0x0000” type=“pci”
                        function=“0x0” />
                </video>
                <memballoon model=“virtio”>
                    <address slot=“0x05” bus=“0x00”
domain=“0x0000” type=“pci”
                        function=“0x0” />
                </memballoon>
            </devices>
        </domain>
    </query>
</iq>
```

At step 350, the CNA or policy server uses the information received to identify the appropriate policy or service to be associated with this request. For example, the policy server can determine that this is a new network, and it can allocate any network identification number for this network. It can also determine that because of the existing policies some of the QoS or ACL requests of the VM must be rejected whereas additional parameters must be set. Thus, the policy server will determine such parameters such as the ISID number for PBB encapsulation, or the Label value for MPLS encapsulation, or QoS parameters, ACLs, rate limiting parameters and so on. For L3 designs, the policy will include the VRF configuration, VPN id, route targets, etc. Once the policy server has determined all the information it transmits back to the VCM the corresponding policies. An example of the information transmitted is shown in the following XML description:

```
<iq id=“dv4R5-4” to=“tor@localhost/nuage”
from=“cna@localhost/nuage”
    type=“result”>
    <query xmlns=“alu:iq:nuage”>
        <virtualMachine>
            <name>Test</name>
            <uuid>1c003190-7a4b-11e1-9fc6-00224d697679</uuid>
            <enterprise>BOA</enterprise>
            <group>finance</group>
            <user>bob</user>
            <application>webapp</application>
            <vrf>
                <service-id>2</service-id>
                <customer-id>1</customer-id>
                <route-distinguisher>1000:1</route-distinguisher>
                <route-target>2000:2</route-target>
                <service-type>1</service-type>
                <route-reflector>172.22.24.34</route-reflector>
            </vrf>
            <interface>
                <ipaddress>192.168.1.3</ipaddress>
                <netmask>255.255.255.0</netmask>
                <gateway>192.168.1.1</gateway>
                <mac>de:ad:a2:c4:b4:3e</mac>
                <dev>de:ad:a2:c4:b4:3e</dev>
            </interface>
            <interface>
                <ipaddress>192.168.2.3</ipaddress>
                <netmask>255.255.255.0</netmask>
                <gateway>192.168.2.1</gateway>
                <mac>de:ad:0e:3e:4a:20</mac>
                <dev>de:ad:0e:3e:4a:20</dev>
            </interface>
        </virtualMachine>
    </query>
</iq>
```

At step 360, when the VCM receives this information it will instantiate the corresponding control/routing protocol service. For example the above description requires that the policy server instantiates a BGP VRF service with a route distinguisher equal to 1000:1 and a route target equal to 2000:1. These control/routing services will exchange information with other VCMs in the network in order to populate the right routes. The VCM will also instantiate any ACLs or QoS parameters according to the instructions received by the policy server. Note, that these instantiations might result in the VCM programming specific entries at the VSW that resides in the hypervisor. The VCM achieves this by, illustratively, communicating with the VAg and propagating the appropriate information.

At step 370, at any time when the control/routing protocols that were instantiated during the previous step identify a new route or other parameter (e.g., determine that in order for a particular VM to communicate with another VM in the system, the packets must be encapsulated in a specific tunnel header), the VCM will responsively program the corresponding forwarding entries in the VSW.

At step 380, since the VSW forwarding entries are now programmed, when the VM starts transmitting packets, the packets will be forwarded based on the rules that have been established by the policy server.

At step 390, in an alternative implementation, the encapsulation of packets into tunnels is performed by the ToR switch, and therefore the forwarding entries are only programmed at the ToR switch.

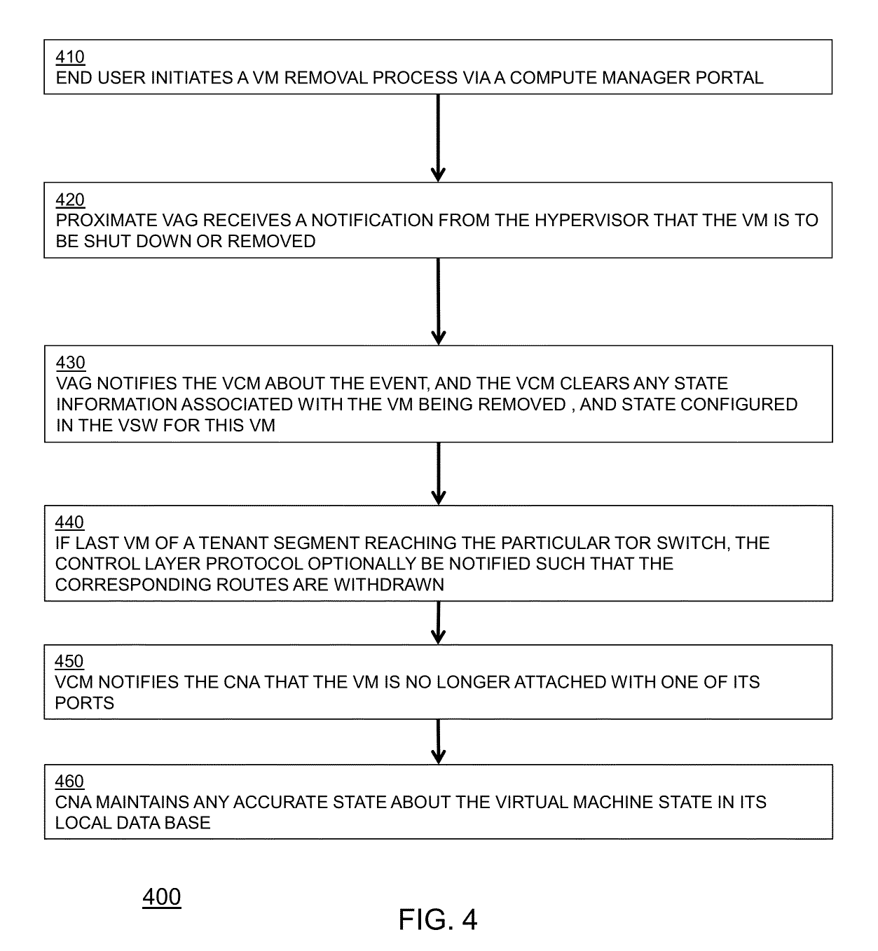

FIG. 4 depicts flow diagram of a method according to an embodiment. Specifically, FIG. 4 depicts a flow diagram of a method 400 for removal of a VM according to an embodiment. The steps associated with VM deletion are similar in float to the steps associated with VM instantiation, such as described above with respect to the method 900 of FIG. 9.

At step 410, via a compute management portal or tool (or other mechanism), the end user initiates a VM removal process.

At step 420, the proximate VAg receives a notification from the hypervisor that the VM is to be shut down or removed.

At step 430, the VAg notifies the VCM about the event, and the VCM clears any state associated with the VM being removed. The VCM also clears any state configured in the VSW for this VM.

At step 440, if this is a last VM of a tenant segment reaching the particular ToR switch, the control layer protocol (BGP for example) may be notified such that the corresponding routes are withdrawn.

At step 450, the VCM notifies the CNA that the VM is no longer attached with one of its ports.

At step 460, the CNA maintains any accurate state about the virtual machine state in its local data base.

In various data center environments, one of the requirements is to enable migration of live VMs to a new server. The use cases for VM migration are usually around load re-distribution in servers, energy savings, and potentially disaster recovery. Although in several instances the problem is addressed not by live migration but warm reboot in a new machine, the convenience of live migration has made it very popular. Thus, various embodiments support such live migration of VM's to a new server. Generally speaking, migration of live VM's generally comprises a VM deletion and the VM instantiation.

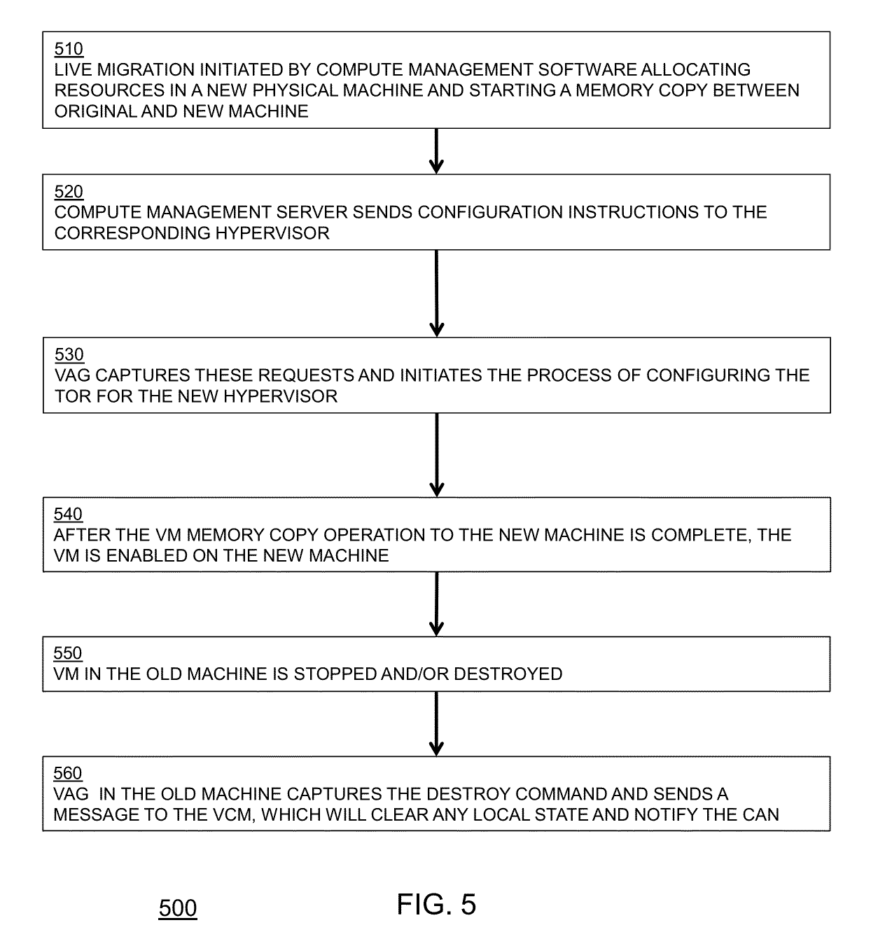

FIG. 5 depicts a flow diagram of a method according to one embodiment. Specifically, FIG. 5 depicts a flow diagram of a method 500 for live migration of VMs.

At step 510, a live migration is initiated by the compute manager allocating resources in a new physical machine, and then starting a memory copy between the original machine and the new one.

At step 520, the compute manager sends configuration instructions to the corresponding hypervisor. Step 520 may occur contemporaneously with step 510.

At step 530, the proximate VAg captures these requests and initiates the process of configuring the VCM for the new hypervisor. This allows the VCM to setup the corresponding profiles and enable the traffic flows. The process for setting up the network services in the new VCM is the same as during any other virtual machine instantiation. The only difference is that the VCM notifies the CNA that this is a virtual machine migration and therefore the CNA can keep track of the operation in its local data bases.

At step 540, after the VM memory copy operation to the new machine is complete, the VM is enabled on the new machine.

At step 550, the VM in the old machine is stopped and/or destroyed.

At step 560, the VAg in the old machine captures the destroy command and sends a message to the VCM. The VCM will clear any local state and notify the CNA as it would do for any other virtual machine removal.

The method 500 described above contemplates that a VM image file system is already mounted on both the originating and target hypervisors. Mounting the file systems on demand will require some additional actions that will be explained after the storage options are outlined. This will fall under the category of “storage migration”.

The various embodiments discussed above contemplate VM-related functions such as instantiation, removal, migration and the like. However, in addition to VM-related functions, various embodiments are also capable of processing a range of appliances that do not rely on virtual technologies. For example, such appliances may comprise network service appliances such as load balancers, firewalls, traffic accelerators etc., as well as compute related appliances that need to consume network services such as bare metal servers, blade systems, storage systems, graphic processor arrays and the like. In each of these cases, the various automation methodologies and mechanisms described herein may be adapted for instantiating and interconnecting DC network services to such appliances.

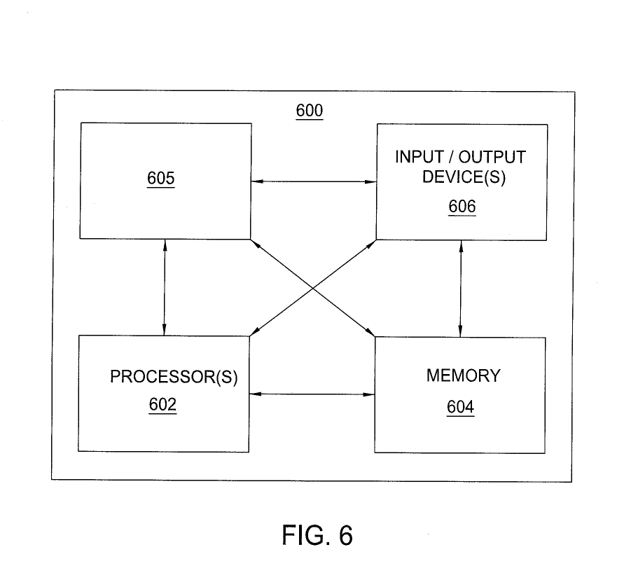

FIG. 6 depicts a high-level block diagram of a computing device such as a processor in a telecom or data center network element, suitable for use in performing functions described herein. Specifically, the computing device 600 described herein is well adapted for implementing the various functions described above with respect to the various data center (DC) elements, network elements, nodes, routers, management entities and the like, as well as the methods/mechanisms described with respect to the various figures.

As depicted in FIG. 6, computing device 600 includes a processor element 603 (e.g., a central processing unit (CPU) and/or other suitable processor(s)), a memory 604 (e.g., random access memory (RAM), read only memory (ROM), and the like), a cooperating module/process 605, and various input/output devices 606 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in software and/or in a combination of software and hardware, e.g., using a general purpose computer, one or more application specific integrated circuits (ASIC), and/or any other hardware equivalents. In one embodiment, the cooperating process 605 can be loaded into memory 604 and executed by processor 603 to implement the functions as discussed herein. Thus, cooperating process 605 (including associated data structures) can be stored on a computer readable storage medium, e.g., RAM memory, magnetic or optical drive or diskette, and the like.

It will be appreciated that computing device 600 depicted in FIG. 6 provides a general architecture and functionality suitable for implementing functional elements described herein or portions of the functional elements described herein.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, transmitted via a tangible or intangible data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method for instantiating network services within a data center (DC), comprising:
creating a registration event in response to a detected compute event;
retrieving policy information associated with the detected compute event to identify thereby relevant types of services; and
configuring DC services to provide the relevant types of services if the detected compute event is authorized.

2. The method of claim 1, further comprising:
identifying a requesting tenant associated with the detected compute event;
retrieving policy information associated with the detected requesting tenant to determine thereby whether the detected compute event is authorized.

3. The method of claim 1, wherein said registration event is created by a Virtualswitch Control Module (VCM) within a switch associated with a plurality of servers, said servers including a hypervisor adapted to instantiate virtual machines (VMs).

4. The method of claim 3, wherein said compute event is detected by a Virtual Agent (VAg) instantiated within a hypervisor in response to said hypervisor instantiating a virtual machine (VM).

5. The method of claim 4, wherein said interaction comprises tenant interaction with a compute manager which responsively defines a virtual machine within a server including said hypervisor.

6. The method of claim 3, wherein said compute event is detected in response to said VCM interacting with said switch.

7. The method of claim 3, wherein said registration event comprises:
forwarding, toward a Cloud Network Automation (CNA) entity, compute event information adapted to cause said CNA to retrieve said policy information and responsively configure said DC services that the detected compute event is authorized.

8. The method of claim 7, said DC services are provided in a distributed manner by network elements within the DC.

9. The method of claim 3, wherein said VCM instantiates control protocol services associated with an authorized compute event.

10. The method of claim 9, wherein said VCM responsively programs new forwarding entries in a virtual switch (VSW) in response to an instantiated control protocol service identifying a new route.

11. The method of claim 10, wherein routing is based upon rules established by said policy information.

12. The method of claim 3, wherein encapsulation of packets into tunnels is performed by said switch.

13. The method of claim 3, wherein said VCM, in response to a notification from a VAg that a VM is to be shut down, clears state information in the VSW associated with the VM to be shut down.

14. The method of claim 13, wherein said VCM notifies said CNA that said VM is no longer attached with a port, said notification adapted to cause said CNA to update a state associated with said VM.

15. The method of claim 1, wherein said policy information includes a Service Level Agreement (SLA) of a tenant initiating said compute event.

16. The method of claim 1, wherein said compute event comprises an interaction indicative of a request to add or remove virtual compute or storage resources.

17. The method of claim 1, wherein said compute event comprises an interaction indicative of a request to add or remove an appliance accessed using virtual compute or storage resources

18. An apparatus for instantiating network services within a data center (DC), the apparatus comprising:
a processor configured for:
creating a registration event in response to a detected compute event;
retrieving policy information associated with the detected compute event to identify thereby relevant types of services; and
configuring DC services to provide the relevant types of services if the detected compute event is authorized.

19. A tangible and non-transient computer readable storage medium storing instructions which, when executed by a computer, adapt the operation of the computer to perform a method for instantiating network services within a data center (DC), the method comprising:
creating a registration event in response to a detected compute event;
retrieving policy information associated with the detected compute event to identify thereby relevant types of services; and
configuring DC services to provide the relevant types of services if the detected compute event is authorized.

20. A computer program product wherein computer instructions, when executed by a processor in a network element, adapt the operation of the network element to provide a method for instantiating network services within a data center (DC), the method comprising:
creating a registration event in response to a detected compute event;
retrieving policy information associated with the detected compute event to identify thereby relevant types of services; and
configuring DC services to provide the relevant types of services if the detected compute event is authorized.
